(19) United States
(12) Patent Application Publication
(10) Pub. No.: US 2012/0222875 A1
(43) Pub. Date: Sep. 6, 2012

(54) Proximal Area Sanitizer

(76) Inventor: Joel Shane MILNER, Greencove Springs, FL (US)

(21) Appl. No.: 13/412,488

(22) Filed: Mar. 5, 2012

Related U.S. Application Data
(60) Provisional application No. 61/449,215, filed on Mar. 4, 2011.

(51) Int. Cl. A01B 1/00; A01B 1/24

(52) U.S. Cl. 172/22

(57) ABSTRACT

The proximal area sanitizer is an apparatus that allows a user to remove and clean the grass and dirt situated above and around a termite bait station. The apparatus mainly comprises a tube, a squared top, a hollow space, and a handle. The tube has a tubular shape, which allows the user to create a circular cut into the grass and dirt surrounding the top of the termite bait station. The squared top is connected to the tube and allows the user to apply an even force onto the top of the apparatus in order to press the tube into the ground. The hollow space is used to cap the top of the termite bait station. The handle is rotatably connected to the tube and allows the user to pull the apparatus out of the ground once the circular cut is made.

The current application claims a priority to the U.S. Provisional Patent application Ser. No. 61/449,215 filed on Mar. 4, 2011.

### FIELD OF THE INVENTION

The present invention relates generally to a device that cleans the surrounding area of a termite monitoring station.

### BACKGROUND OF THE INVENTION

Termites do more property damage in the United States than hurricanes, earthquakes and vandalism combined. A method of controlling termites commonly utilizes a termite bait station. The termite bait station contains toxic baits with termiticide incorporated. The termite bait station is often planted into the ground surrounding the house or a wooden structure. Over time, grass and dirt may grow over the bait station obstructing its presence for a termite technician to detect. Oftentimes, the termite technician resorts to uncovering the bait station by stomping into the ground or kicking the bait station to remove the dirt and grass. These actions often damage the bait station. The present invention provides a method of removing the dirt and grass situated above the termite bait station for easy access and maintenance by the termite technician.

### BRIEF DESCRIPTION OF THE DRAWINGS

FIG. 1 is a perspective view of the present invention.

FIG. 2 is a side view of the present invention.

FIG. 3 is a top view of the present invention.

### DETAIL DESCRIPTIONS OF THE INVENTION

All illustrations of the drawings are for the purpose of describing selected versions of the present invention and are not intended to limit the scope of the present invention.

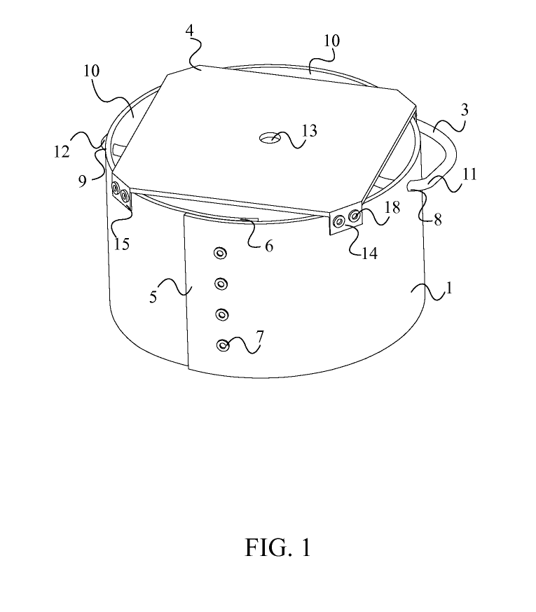

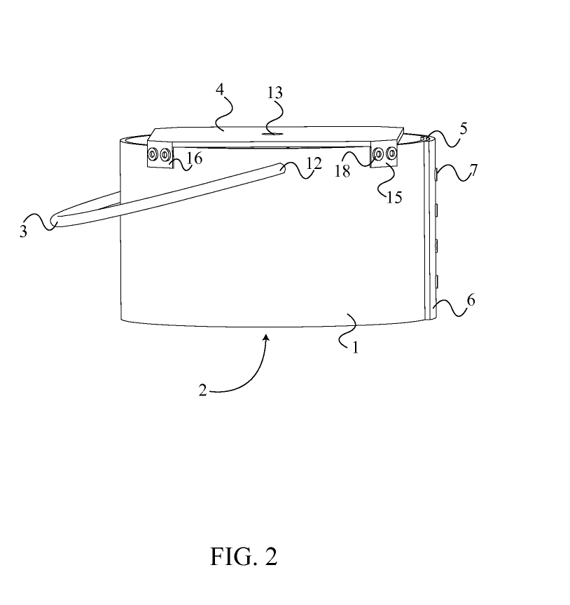

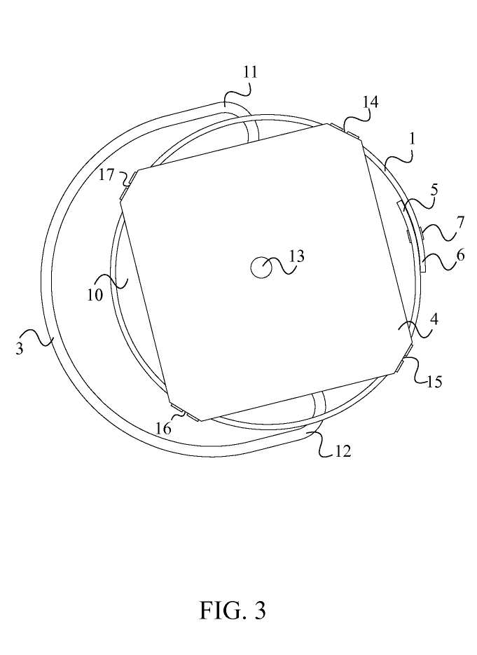

As can be seen in FIG. 3, the present invention is a proximal area sanitizer made from a tube 1 with a hollow space 2, a handle 3 and a squared top 4. The tube 1 is a malleable sheet that has been rolled up. The cross-section of the tube 1 may be of various shapes such as an oval, a circle, a rectangular or a hexagon. In the preferred embodiment, the tube 1 has a circular cross-section and is made of galvanized sheet metal. The tube 1 has a first end 5 connected to a second end 6. More specifically, the first end 5 is connected to the second end 6 by rivets 7 in the preferred embodiment of the present invention. The first end 5 and the second side 6 are connected in such a way to stabilize the tubular form of tube 1 and prevent tube 1 from unwinding back into its sheet form. As can be seen in FIG. 2, the volume within the tube 1 is the hollow space 2. The hollow space 2 allows the proximal area sanitizer to contain debris capped inside the present invention. The depth of the hollow space 2 also allows the present invention to penetrate deep into the ground until the proximal area sanitizer touches the top of the termite monitoring station. Moreover, the hollow space 2 allows the captured grass and dirt to be removed from the top of the termite monitoring station, which can then be accessed by the termite technician for maintenance. Located on the tube 1 are a left handle hole 8 and a right handle hole 9, which can be seen in FIG. 1. The left handle hole 8 is diametrically opposed to the right handle hole 9 on the lateral surface of the tube 1. The left handle hole 8 and the right handle hole 9 laterally traverse the tube 1. The left handle hole 8 and the right handle hole 9 respectively allow a first hook 11 and a second hook 12 of the handle 3 to be attached to the tube 1.

Attached atop to the tube 1 is a squared top 4 with a center hole 13, which can be seen in FIG. 1. The center hole 13 is positioned concentrically to the circular cross section of the tube 1 in the preferred embodiment. The squared top 4 is connected perpendicularly to the tube 1. In the preferred embodiment, the squared top 4 is a squared malleable sheet with four corners. Each corner has a tab perpendicularly connected. Therefore, the squared top 4 has a first tab 14, a second tab 15, a third tab 16, and a fourth tab 17, which can be seen in FIG. 3. The first tab 14, the second tab 15, the third tab 16, and the fourth tab 17 allow the squared top 4 to be connected to the tube 1. The first tab 14, the second tab 15, the third tab 16 and the fourth tab 17 are all situated outside the lateral surface of the tube 1 with their entireties attached to the tube 1. In the preferred embodiment, there are eight top rivets 18 connecting the squared top 4 to the tube 1. The connection of the squared top 4 to the tube 1 allows the user to apply a uniform force with his/her boot to press the present invention into the ground. The center hole 13 allows the user to access the termite monitoring station located at the bottom of the squared top 4 and to allow the captured debris to be easily removed from the present invention. For example, once the user has capped the present invention into the ground, s/he can remove the captured debris by putting a stick through the center hole 13. The area of the squared top 4 does not entirely cover the cross-sectional area of the tube 1. Therefore, there are a plurality of cross-sectional spaces 10 between the sides of the squared top 4 and the tube 1. The plurality of cross-sectional spaces 10 are concentrically distributed around the center hole 13 of the squared top 4. The plurality of cross-sectional spaces 10 allow the captured debris to be easily removed from the present invention. For example, if the debris is still attached to the present invention, s/he can remove the debris by removing it through the plurality of cross-sectional spaces 10.

Attached to the side of the tube 1 is the handle 3. The material of the handle 3 may be composed of metal, fibers, or plastic. The handle 3 has the first hook 11 traversed onto the side of the tube 1 via the left handle hole 8 and the second hook 12 traversed onto the other side of the tube 1 via the right handle hole 9. The handle 3 allows the user to disengage the present invention with an upward pull. The handle 3 also allows the present invention to be portable and easy to carry along with the toolkit of the termite technician. To use the present invention, the user places the proximal area sanitizer over the overgrown or buried monitoring station. The termite technician then steps on the proximal area sanitizer, cutting the grass and loosening the dirt around the monitoring station. The technician then grabs the handle 3 of the proximal area sanitizer and pulls up, which leaves a circular cut around the monitoring station.

Although the invention has been explained in relation to its preferred embodiment, it is to be understood that many other possible modifications and variations can be made without departing from the spirit and scope of the invention as hereinafter claimed.

What is claimed is:

1. A proximal area sanitizer comprises:
a tube;
a hollow space;
a handle;
a squared top;
the tube comprises a first end, a second end, a left handle hole, a right handle hole, and a plurality of cross-sectional spaces;
the handle comprises a first hook and a second hook;
the squared top comprises a center hole, a first tab, a second tab, a third tab, and a fourth tab;
the hollow space being positioned inside the tube;
the first end being connected to the second end;
the squared top being connected perpendicularly to the tube;
the center hole being concentrically aligned to the hollow space;
the plurality of cross-sectional spaces being concentrically distributed around the center hole; and
the handle being attached to the tube.

2. The proximal area sanitizer as claimed in claim 1 comprises,
the squared top being connected to the tube via the first tab;
the squared top being connected to the tube via the second tab;
the squared top being connected to the tube via the third tab; and
the squared top being connected to the tube via the fourth tab.

3. The proximal area sanitizer as claimed in claim 1 comprises,
the first tab being connected perpendicularly to the squared top;
the second tab being connected perpendicularly to the squared top;
the third tab being connected perpendicularly to the squared top;
the fourth tab being connected perpendicularly to the squared top;
the handle being attached to the tube via the first hook; and
the handle being attached to the tube via the second hook.

4. A proximal area sanitizer comprises:
a tube;
a hollow space;
a handle;
a squared top;
the tube comprises a first end, a second end, a left handle hole, a right handle hole, and a plurality of cross-sectional spaces;
the handle comprises a first hook and a second hook;
the squared top comprises a center hole, a first tab, a second tab, a third tab, and a fourth tab;
the hollow space being positioned inside the tube;
the first end being connected to the second end;
the squared top being connected perpendicularly to the tube;
the center hole being concentrically aligned to the hollow space;
the plurality of cross-sectional spaces being concentrically distributed around the center hole;
the handle being attached to the tube;
the squared top being connected to the tube via the first tab;
the squared top being connected to the tube via the second tab;
the squared top being connected to the tube via the third tab; and
the squared top being connected to the tube via the fourth tab.

5. The proximal area sanitizer as claimed in claim 4 comprises,
the first tab being connected perpendicularly to the squared top;
the second tab being connected perpendicularly to the squared top;
the third tab being connected perpendicularly to the squared top;
the fourth tab being connected perpendicularly to the squared top;
the handle being attached to the tube via the first hook; and
the handle being attached to the tube via the second hook.

6. A proximal area sanitizer comprises:
a tube;
a hollow space;
a handle;
a squared top;
the tube comprises a first end, a second end, a left handle hole, a right handle hole, and a plurality of cross-sectional spaces;
the handle comprises a first hook and a second hook;
the squared top comprises a center hole, a first tab, a second tab, a third tab, and a fourth tab;
the hollow space being positioned inside the tube;
the first end being attached to the second end via;
the squared top being connected perpendicularly to the tube;
the center hole being concentrically aligned to the hollow space;
the plurality of cross-sectional spaces being concentrically distributed around the center hole;
the handle being attached to the tube;
the squared top being connected to the tube via the first tab;
the squared top being connected to the tube via the second tab;
the squared top being connected to the tube via the third tab;
the squared top being connected to the tube via the fourth tab;
the first tab being connected perpendicularly to the squared top;
the second tab being connected perpendicularly to the squared top;
the third tab being connected perpendicularly to the squared top;
the fourth tab being connected perpendicularly to the squared top;
the handle being attached to the tube via the first hook; and
the handle being attached to the tube via the second hook.
